(19) United States
(12) Patent Application Publication
(10) Pub. No.: US 2024/0174788 A1
(43) Pub. Date: May 30, 2024

(54) Aging-Resistant Moisture-Curing Compositions

(71) Applicant: Covestro Deutschland AG, Leverkusen (DE)

(72) Inventors: Winfried Jeske, Burscheid (DE); Ute Nattke, Leverkusen (DE)

(21) Appl. No.: 18/281,105

(22) PCT Filed: Mar. 8, 2022
(86) PCT No.: PCT/EP2022/055798

§ 371 Date: Sep. 8, 2023

(30) Foreign Application Priority Data
Mar. 11, 2021 (EP) 21162179.2

(51) Int. Cl. C08G 18/10; C08G 18/46; C08K 3/26; C08K 5/00; C08K 5/17; C08K 5/42

(52) U.S. Cl. CPC C08G 18/10; C08G 18/4692; C08K 5/005; C08K 5/17; C08K 5/42; C08G 2150/90; C08G 2170/00; C08G 2190/00; C08K 2003/265

(57) ABSTRACT

The present invention relates to aging-resistant moisture-curing compositions on the basis of silane-functional prepolymers that contain amino-functional compounds as the anti-aging agent. The invention also relates to the cured compositions obtainable therefrom and the use of these moisture-curing compositions or the cured compositions as sealants, adhesives and coatings.

### CROSS-REFERENCE TO RELATED APPLICATIONS

This application is the United States national phase of International Application No. PCT/EP2022/055798 filed Mar. 8, 2022, and claims priority to European Patent Application No. 21162179.2 filed Mar. 11, 2021, the disclosures of which are hereby incorporated by reference in their entireties.

### BACKGROUND OF THE INVENTION

### Field of the Invention

The present invention relates to aging-resistant moisture-curing compositions based on silane-functional prepolymers containing amino-functional compounds as aging stabilizers. The cured compositions obtainable therefrom, and the use of these moisture-curing compositions, or of the cured compositions, as sealants, adhesives and coatings.

### Description of Related Art

Compositions based on silane-functional prepolymers (especially silane-terminated prepolymers, STPs for short) and the use thereof as adhesives, sealants and coatings have long been known. The mechanism of crosslinking of these silanes is via a two-stage process: firstly, ambient air humidity hydrolyzes an alkoxysilane group to a hydroxysilane group. This hydroxysilane group can condense in a second step with an alkoxysilane group or a second hydroxysilane group. On completion of hydrolysis, a network of siloxane groups is formed.

A “silane group” is understood to mean a chemical group comprising a silicon atom which firstly has at least one covalent silicon-carbon bond and which secondly is not linked to a further silicon atom via an oxygen atom. Groups containing at least two silicon atoms bonded to one another via an oxygen atom, i.e. containing an (Si—O—Si) structure fragment, are siloxane groups.

Silane-terminated prepolymers (STPs) refer to silane-functional prepolymers each having silane groups at the ends (termini) of the prepolymer backbone.

There are several options for the synthesis of silane-functional prepolymers, especially of silane-terminated prepolymers: firstly, an alkoxysilane can be bound via an isocyanate-reactive group as functional group, such as hydroxy, amino or mercapto, to an isocyanate-containing polyurethane prepolymer. Alternatively, an isocyanate-functional alkoxysilane may be bound to a polymer bearing isocyanate-reactive groups, for example hydroxy, amino or mercapto. A further option for preparing silane-terminated prepolymers is the hydrosilylation of double bonds.

In addition, there are also other options for preparation of alkoxysilane-containing prepolymers. For instance, it is also possible to react polymeric polyisocyanates that are prepared by oligomerization of monomeric diisocyanates with alkoxysilane containing an isocyanate-reactive group.

Prepolymers containing alkoxysilane groups can also be contained by polymerization of epoxides, in that epoxides comprising alkoxysilane groups are present in the reaction mixture. EP 2 093 244 describes a process with the aid of which polyethers containing alkoxysilane groups are prepared from epoxides (for example propylene oxide and alkoxysilane-containing epoxides). In said polyether, the alkoxysilane groups may be arranged arbitrarily in blockwise succession or incorporated randomly into the modified polymer chain. In this regard, see examples 1-4 in particular of this document. By contrast with the above-described prepolymers, the alkoxysilanes are not only attached to the termini of the chains. Published specifications DE 10 2010 038 768, DE 10 2010 038 774 and DE 10 2011 006 313 disclose further developments of the polyethers containing alkoxysilane groups by processes of EP 2 093 244.

DE 10 2010 038 768 and DE 10 2010 038 774 describe ways of stabilizing or blocking the terminal OH groups of these alkoxysilane polyethers such that no unwanted condensation of these OH groups with the alkoxysilanes can take place. The alkoxysilane polyethers underlying these patent applications are prepared by the underlying method of EP 2 093 244 and are modified at the terminal OH group.

According to the technical teaching of patent specification DE 10 2011 006 313, longer-chain polyethers than in the three aforementioned documents are used as starter molecules; otherwise, the synthesis of the polymers described is likewise based on the teaching of EP 2 093 244.

A further way of preparing alkoxysilane-containing polymers is based on the conversion of unsaturated compounds. One is to react a polymeric compound having unsaturated groups with a hydrosilane in a hydrosilylation of the double bond. A further way is the copolymerization of unsaturated monomers having C═C double bonds with those monomers having polymerizable C═C double bonds that bear an alkoxysilane group. For discussion of these two ways, see U.S. Pat. No. 4,368,297, column 3 lines 37-42. U.S. Pat. No. 4,368,297 describes, in example 1, the hydrosilylation of an acrylate polymer containing allyl groups with methyldimethoxysilane. Examples 6 and 7 disclose the free-radical polymerization of unsaturated monomeric compounds without an alkoxysilane radical (methacrylate compounds and maleic anhydride) in the presence of proportions of alkoxysilane-containing methacrylate compounds. U.S. Pat. No. 5,886,125 describes the copolymerization of hydroxypropyl methacrylate, an unsaturated silane-free monomer, and vinyltrimethoxysilane. WO 00/55229 likewise gives examples of alkoxysilane-containing polymers formed from unsaturated monomers. The silane polymer 1 is synthesized (page 15 line 25) by free-radical polymerization of styrene, isobornyl methacrylate and two further silane-free monomers with methacryloyloxypropyltrimethoxysilane. Similar products formed from silane-free acrylates, styrene and vinylsilane are described in WO 03/078486 in examples 1-11. In EP 2 011 834, example 1 describes the hydrosilylation of a polymer containing allyl groups with trimethoxysilane.

But the polymer backbone is not restricted solely to the above-described groups (polyurethane prepolymers, polymeric polyisocyanates, polymers containing epoxy and C═C groups). Furthermore, there are also many other conceivable groups, as specified in EP 2 011 834 in column [016].

Silane-functional prepolymers, especially silane-terminated prepolymers (STPs), form the basis for production of elastic sealants or adhesives, especially parquet adhesives. Skillful selection of further additions such as binders, fillers, plasticizers and other additives allows controlled adjustment of mechanical and chemical properties and curing rates. Elastic adhesives have gained an established position in industry, in repair facilities, in workshops and among professional and amateur craftspeople, for instance in vehicle construction, in construction or in shipbuilding and aerospace.

Among the advantages of the systems based on silane-functional prepolymers over polyurethane-based systems that crosslink via reactive NCO groups are that there is no unwanted blistering as a result of carbon dioxide in thick layers, and that it is possible to dispense with the application of an adhesion-promoting layer in many cases.

The use of antioxidants can increase the long-term stability of adhesive, sealant and coating formulations based on silane-functional prepolymers. Only phenolic antioxidants have been used to date in such formulations. Such phenolic antioxidants are commercialized, for example, under the brand names Irganox®, Tinuvin® and Vulkanox®.

The improvement achieved in stability to aging and oxidation through use of the prior art aging stabilizers is frequently inadequate. This can lead to premature embrittlement or softening of adhesive bonds, seals and coatings, and to failure thereof.

It has been found that the parquet adhesives based on silane-functional prepolymers that are available on the market do not meet the demands on the service life of the adhesive bond in all cases if they are used in such a way that the adhesive bond is subject to elevated thermal stress (Boden Wand Decke, January 2016 edition, page 48). Thermal stress can cause conversion of such adhesives from the solid state to a soft, pasty, crumbly or even pulverulent state. This is a risk in particular when the adhesives are used for bonding of floor coverings on top of underfloor heating.

### SUMMARY OF THE INVENTION

It is therefore an object of the present invention to provide moisture-curing compositions based on silane-functional prepolymers, especially silane-terminated prepolymers, which overcome the disadvantages of the prior art, and to provide aging stabilizers for adhesive, sealant and coating formulations based on silane-functional prepolymers, especially silane-terminated prepolymers, the use of which therein improves the aging stability of the composition in the cured state.

According to the invention, this object is achieved by a composition based on silane-functional prepolymers, especially silane-terminated prepolymers, containing aminic aging stabilizers.

The present invention therefore provides compositions, especially for bonding, sealing or coating, comprising or consisting of
A) at least one silane-functional prepolymer having at least one alkoxysilane group,
B) at least one amino-functional compound that acts as aging stabilizer, excluding compounds of the oxalanilide type and compounds having 2,2,6,6 tetramethylpiperidinyl groups from component B,
C) optionally a catalyst component, and
D) optionally additives and/or auxiliaries, excluding aging stabilizers that are covered by the definition of component B.

In general, an aging stabilizer is understood to mean chemical substances that are added to other substances or substance mixtures in order to protect the latter from unwanted aging processes or to delay aging. “Aging” is a change in the physical and chemical properties of a substance after prolonged storage or in use.

As used in this application, the term “aliphatic” is to stand for optionally substituted, linear or branched, alkyl, alkenyl and alkynyl groups, in which nonadjacent methylene groups (—CH₂—) may be replaced by heteroatoms, such as oxygen and sulfur in particular, or by secondary amino groups.

As used in this application, the term “alicyclic” or “cycloaliphatic” is to stand for optionally substituted carbocyclic or heterocyclic compounds which are not included in the aromatic compounds, such as, for example, cycloalkanes, cycloalkenes or oxa-, thia-, aza- or thiazacycloalkanes. Specific examples thereof are cyclohexyl groups, cyclopentyl groups, and also the derivatives thereof that are interrupted by one or two N or O atoms, such as pyrimidine, pyrazine, tetrahydropyran or tetrahydrofuran. Further examples of alicyclic groups are polyisocyanates having ring structures such as iminooxadiazinedione, oxadiazinetrione, oxazolidinone, allophanate, cyclic isocyanurate, cyclic uretdione, cyclic urethane, cyclic biuret, cyclic urea, acyl urea and/or carbodiimide structures.

As used in this application, the term “optionally substituted” or “substituted” is to stand in particular for substitution of the relevant structural unit by —F, —Cl, —I, —Br, —OH, —OCH₃, —OCH₂CH₃, —O-isopropyl or —O-n-propyl, —OCF₃, —CF₃, —S—, C₁₋₆-alkyl and/or another linear or branched, aliphatic and/or alicyclic structural unit having 1 to 12 carbon atoms and optionally linked via a heteroatom. It preferably stands for substitution by halogen (especially —F, —Cl), C₁₋₆-alkoxy (especially methoxy and ethoxy), hydroxyl, trifluoromethyl and trifluoromethoxy.

As used in this application, the term “low molecular mass” is to stand for compounds whose molecular mass is up to 800 g/mol.

As used in this application, the term “high molecular mass” is to stand for compounds whose molecular mass exceeds 800 g/mol.

As used in this application, the term “polyisocyanate” is to stand for aliphatic, aromatic or cycloaliphatic polyisocyanates with an NCO functionality of >1, preferably ≥2, more particularly di- and triisocyanates.

As used in this application, the term “monomer” is to stand for a low molecular mass compound having functional groups that participates in the synthesis of polymers and has a defined molar mass.

As used in this application, the term “polymer” is to stand for compounds in which monomers of the same or different kinds are linked repeatedly to one another, and which may differ in terms of degree of polymerization, molar mass distribution and/or chain length. A polymer according to the present invention is consequently a compound having at least one structural unit in its molecular structure, which repeats at least once and has been inserted covalently into the molecular structure during the polymer synthesis through involvement of a monomer.

As used in this application, the term “prepolymer” is to stand for a polymer having functional groups.

Analogously to the polymer definition, the molecular structure of the prepolymer is formed by repeated linking of at least two monomers of the same or different kinds to one another. The prepolymer is involved in the final synthesis of polymers that have a greater molecular weight than the prepolymer. The term “prepolymer” thus includes polymeric compounds that are each reactive via at least one functional group present in the molecule and can react, with formation of a repeat unit, to form a (preferably crosslinked) polymer. “Alkoxysilane-functionalized prepolymers” contain (if appropriate as well as other functional groups) at least one alkoxysilane group as functional group. The term “alkoxysilane-functionalized prepolymers” includes both “alkoxysilane-functionalized polyurethane prepolymers” and “alkoxysilane-functionalized polymeric polyisocyanates”, and also the alkoxysilane group-containing polymers mentioned at the outset according to published specifications EP 2093244, DE 102010038768, DE 102010038774 and DE102011006313, and alkoxysilane-containing polymers according to documents WO 00/55229, WO 03/078486, U.S. Pat. Nos. 5,162,426 and 5,886,125.

For the purposes of this application, the term “blocked” signifies “reversibly blocked”. Accordingly, for example, isocyanate can be released again from a blocked isocyanate group by heating; blocked isocyanate groups therefore continue to be reactive with polyols. A blocked isocyanate is typically understood as an addition compound of a highly reactive isocyanate with an alcohol (to form a urethane) or with an amine (to form a urea), which at higher temperatures breaks down again into alcohol or amine, respectively, and into isocyanate. Known blocking agents are, for example, acetoacetic acid, malonic esters, 3,5-dimethylpyrazole, butanone oxime, secondary amines, caprolactam, or various alcohols.

Unless indicated otherwise by the context, the term “isocyanate group” in this application always embraces free isocyanate groups (—NCO) and blocked isocyanate groups.

### BRIEF DESCRIPTION OF THE DRAWINGS

FIGS. 1a) and 1b) show change in viscosity as a function of shear rate for examples 1.1, 1.2 and 1.3 after a) storage at RT for 7 days and b) after storage at 50° C. for a further 84 days.

FIG. 2 shows the drop in hardness on hot storage for examples 2.1-2.3.

FIG. 3 shows the hot storage at 100° C. for examples 1.1-1.3.

### DESCRIPTION OF THE INVENTION

Preferred silane-functional prepolymers having at least one alkoxysilane group have a number-average molecular weight Mn of not more than 30 000 g/mol, preferably not more than 20 000 g/mol, more preferably not more than 15 000 g/mol.

Preferred silane-functional prepolymers having at least one alkoxysilane group have a number-average molecular weight Mn of at least 500 g/mol, preferably at least 800 g/mol, more preferably at least 1000 g/mol.

In the case of compounds whose molecular mass does not arise from a precisely defined structural formula, as in the case of polymers, for example, molecular mass refers in each case to the number-average molecular weight. The number-average molecular weight Mn is determined by gel permeation chromatography (GPC) in tetrahydrofuran at 23° C. The procedure is in accordance with DIN 55672-1: “Gel permeation chromatography, Part 1—Tetrahydrofuran as eluent” (SECurity GPC System from PSS Polymer Service, flow rate 1.0 ml/min; columns: 2×PSS SDV linear M, 8×300 mm, 5 μm; RID detector). Polystyrene samples of known molar mass are used for calibration. The number-average molecular weight is calculated by the software. Baseline points and evaluation limits are fixed in accordance with the DIN 55672 Part 1 that was current at the filing date of this patent application.

The composition of the invention preferably comprises at least one silane-functional prepolymer containing at least one alkoxysilane group (preferably at least two alkoxysilane groups) of the general formula (I)

*—R³—Si(R¹)₃₋ₐ(OR²)ₐ (I)

where
R¹ is an alkyl group having 1 to 8 carbon atoms;
R² is an alkyl group having 1 to 12 carbon atoms;
R³ is a linear or branched, optionally cyclic, alkylene group having 1 to 18 carbon atoms, optionally having aromatic moieties, and optionally having one or more heteroatoms; and
a has a value of 1 or 2 or 3.

* in formula (I) represents an unoccupied valence of the radical/structure fragment identified thereby to which the prepolymer binds.

It is preferable in accordance with the invention when R¹ of the formula (I) represents a methyl group or an ethyl group, more preferably a methyl group.

It is preferable in accordance with the invention when R² of the formula (I) for any —OR² radical of the formula (I) is independently a methyl group or an ethyl group. In this case, the alkoxy radicals of the alkoxysilane group of the silane-functional prepolymer are selected from ethoxy and/or methoxy groups.

It is preferable in accordance with the invention when R³ of the formula (I) is an alkylene group having 1 to 6 carbon atoms, especially a methylene group (—CH₂—), a 1,3-propylene group, a 1,4-butylene group or a 3,3-dimethyl-1,4-butylene group.

It is preferable in accordance with the invention when a is 2 or 3, especially 3.

It is preferable in accordance with the invention that an alkoxysilane group binds at least to each of the termini of the silane-functional prepolymer. In addition to or instead of the formation of the alkoxysilane group at the termini, it is possible for further alkoxysilane groups to be bonded to the prepolymer, distributed over the polymer backbone.

Suitable silane-functionalized prepolymers are polyurethanes having at least one alkoxysilane group, polymeric polyisocyanates having at least one alkoxysilane group, polymeric polyols having at least one alkoxysilane group, polyether polyols having at least one alkoxysilane group, polyester polyols having at least one alkoxysilane group, polycarbonate polyols having at least one alkoxysilane group, polyacrylate polyols having at least one alkoxysilane group, polymethacrylate polyols having at least one alkoxysilane group and polyurethane polyols having at least one alkoxysilane group.

In a first embodiment, the silane-functional prepolymer is a silane-functional polyurethane prepolymer obtainable by the reaction of a silane having at least one group reactive toward isocyanate groups with a polyurethane polymer having isocyanate groups (the latter also been referred to hereinafter as isocyanate-functional prepolymer). This polyurethane prepolymer is prepared by the reaction of a compound having isocyanate-reactive groups or mixtures of such materials and polyisocyanates, with use of the isocyanate groups in excess over the isocyanate-reactive groups.

Polymeric polyols which are usable for preparing the prepolymers have a number-average molecular weight M. of 400 g/mol to 8000 g/mol, preferably of 400 g/mol to 6000 g/mol and more preferably of 400 g/mol to 3000 g/mol. Their hydroxyl number is 22 to 400 mg KOH/g, preferably 30 to 300 mg KOH/g and more preferably 40 to 250 mg KOH/g and they have an OH functionality of 1.5 to 6, preferably of 1.7 to 5 and more preferably of 2.0 to 5.

Polyols for preparing the prepolymers are the organic polyhydroxyl compounds known in polyurethane coating technology, for example the standard polyester polyols, polyacrylate polyols, polyurethane polyols, polycarbonate polyols, polyether polyols, polyester polyacrylate polyols and polyurethane polyacrylate polyols, polyurethane polyester polyols, polyurethane polyether polyols, polyurethane polycarbonate polyols, polyester polycarbonate polyols, phenol/formaldehyde resins, alone or in mixtures. Preference is given to polyester polyols, polyether polyols, polyacrylate polyols or polycarbonate polyols, particular preference is given to polyether polyols, polyester polyols and polycarbonate polyols.

Polyether polyols include, for example, the polyaddition products of the styrene oxides, of ethylene oxide, of propylene oxide, of tetrahydrofuran, of butylene oxide, of epichlorohydrin, and the mixed addition and grafting products thereof, and the polyether polyols obtained by condensation of polyhydric alcohols or mixtures thereof and those obtained by alkoxylation of polyhydric alcohols, amines and amino alcohols.

Suitable hydroxy-functional polyethers have OH functionalities of 1.5 to 6.0, preferably 1.8 to 3.0, OH numbers of 50 to 700 and preferably of 100 to 600 mg KOH/g of solids, and molecular weights M. of 106 to 4000 g/mol, preferably of 200 to 3500, for example alkoxylation products of hydroxy-functional starter molecules such as ethylene glycol, propylene glycol, butanediol, hexanediol, trimethylolpropane, glycerol, pentaerythritol, sorbitol or mixtures of these and also other hydroxy-functional compounds with propylene oxide or butylene oxide. Preferred polyether components are polypropylene oxide polyols, polyethylene oxide polyols and polytetramethylene oxide polyols.

Examples of polyester polyols that are of good suitability are the polycondensates, known per se, of di- and optionally tri- and tetraols and di- and optionally tri- and tetracarboxylic acids or hydroxycarboxylic acids or lactones. Rather than the free polycarboxylic acids, it is also possible to use the corresponding polycarboxylic anhydrides or corresponding polycarboxylic esters of low alcohols for preparation of the polyesters. Examples of suitable diols are ethylene glycol, butylene glycol, diethylene glycol, triethylene glycol, polyalkylene glycols such as polyethylene glycol, and also propane-1,2-diol, propane-1,3-diol, butane-1,3-diol, butane-1,4-diol, hexane-1,6-diol and isomers, neopentyl glycol or neopentyl glycol hydroxypivalate, preference being given to the three latter compounds. In order to achieve a functionality >2, it is optionally possible to use proportions of polyols having a functionality of 3, for example trimethylolpropane, glycerol, erythritol, pentaerythritol, trimethylolbenzene or trishydroxyethyl isocyanurate.

Useful dicarboxylic acids include, for example, phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid, 2,2-dimethylsuccinic acid. Anhydrides of these acids are likewise usable, where they exist. For the purposes of the present invention, the anhydrides are consequently covered by the expression “acid”. It is also possible to use monocarboxylic acids such as benzoic acid and hexanecarboxylic acid, provided that the mean functionality of the polyol is ≥2. Saturated aliphatic or aromatic acids are preferred, such as adipic acid or isophthalic acid. One example of a polycarboxylic acid for optional additional use in smaller amounts here is trimellitic acid.

Examples of hydroxycarboxylic acids that may be used as co-reactants in the preparation of a polyester polyol having terminal hydroxyl groups include hydroxycaproic acid, hydroxybutyric acid, hydroxydecanoic acid, hydroxystearic acid and the like. Usable lactones include ε-caprolactone, butyrolactone and homologs.

Preference is given to polyester polyols based on butanediol and/or neopentyl glycol and/or hexanediol and/or ethylene glycol and/or diethylene glycol with adipic acid and/or phthalic acid and/or isophthalic acid. Particular preference is given to polyester polyols based on butanediol and/or neopentyl glycol and/or hexanediol with adipic acid and/or phthalic acid.

The useful polycarbonate polyols are obtainable by reaction of carbonic acid derivatives, for example diphenyl carbonate, dimethyl carbonate or phosgene, with diols. Useful diols of this kind include, for example, ethylene glycol, propane-1,2- and 1,3-diol, butane-1,3- and 1,4-diol, hexane-1,6-diol, octane-1,8-diol, neopentyl glycol, 1,4-bishydroxymethylcyclohexane, 2-methylpropane-1,3-diol, 2,2,4-trimethylpentane-1,3-diol, dipropylene glycol, polypropylene glycols, dibutylene glycol, polybutylene glycols, bisphenol A, tetrabromobisphenol A, but also lactone-modified diols. Preferably, the diol component contains 40% to 100% by weight of hexane-1,6-diol and/or hexanediol derivatives, preferably those having not only terminal OH groups but also ether or ester groups, for example products which are obtained by reaction of 1 mol of hexanediol with at least 1 mol, preferably 1 to 2 mol, of ε-caprolactone, or by etherification of hexanediol with itself to give di- or trihexylene glycol. It is also possible to use polyether polycarbonate polyols.

Preference is given to polycarbonate polyols based on dimethyl carbonate and hexanediol and/or butanediol and/or ε-caprolactone. Very particular preference is given to polycarbonate polyols based on dimethyl carbonate and hexanediol and/or ε-caprolactone.

Instead of the above-described polymeric polyether, polyester or polycarbonate polyols, it is also possible to use low molecular weight polyols in the molar weight range from 62-400 g/mol for the preparation of the isocyanate-containing prepolymers. Suitable low molecular weight polyols are short-chain, i.e. containing 2 to 20 carbon atoms, aliphatic, araliphatic or cycloaliphatic diols or triols. Examples of diols are ethylene glycol, diethylene glycol, triethylene glycol, tetraethylene glycol, dipropylene glycol, tripropylene glycol, propane-1,2-diol, propane-1,3-diol, butane-1,4-diol, neopentyl glycol, 2-ethyl-2-butylpropanediol, trimethylpentanediol, 2,2,4-trimethylpentane-1,3-diol, positionally isomeric diethyloctanediols, 1,3-butylene glycol, cyclohexanediol, cyclohexane-1,4-dimethanol, hexane-1,6-diol, cyclohexane-1,2- and -1,4-diol, hydrogenated bisphenol A (2,2-bis(4-hydroxycyclohexyl)propane), 2,2-dimethyl-3-hydroxypropyl 2,2-dimethyl-3-hydroxypropionate. Preference is given to butane-1,4-diol, cyclohexane-1,4-dimethanol and hexane-1,6-diol. Examples of suitable triols are trimethylolethane, trimethylolpropane or glycerol, preference being given to trimethylolpropane.

The stated polyols can be used alone or in a mixture.

The aforementioned isocyanate-reactive compounds may be reacted with all diisocyanates, aromatic and also aliphatic, before the actual prepolymerization to give urethane-modified hydroxyl compounds.

Useful isocyanate-containing components include aromatic, aliphatic and cycloaliphatic diisocyanates, and mixtures thereof. Suitable diisocyanates are compounds of the formula PIC(NCO)₂ having an average molecular weight below 400 g/mol, in which PIC denotes an aromatic C₆-C₁₅ hydrocarbyl radical, an aliphatic C₄-C₁₂ hydrocarbyl radical or a cycloaliphatic C₆-C₁₅ hydrocarbyl radical, for example diisocyanates from the group of butane diisocyanate, pentane 1,5-diisocyanate (PDI), hexane 1,6-diisocyanate (hexamethylene diisocyanate, HDI), 4-isocyanatomethyloctane 1,8-diisocyanate (triisocyanatononane, TIN), 4,4′-methylenebis(cyclohexyl isocyanate), 3,5,5-trimethyl-1-isocyanato-3-isocyanatomethylcyclohexane (isophorone diisocyanate, IPDI), 2,4- and/or 2,6-methylcyclohexyl diisocyanate (H₆TDI) and ω,ω′-diisocyanato-1,3-dimethylcyclohexane (HXDI), xylylene diisocyanate (XDI), 4,4′-diisocyanatodicyclohexylmethane, tetramethylene diisocyanate, 2-methylpentamethylene diisocyanate, 2,2,4-trimethylhexamethylene diisocyanate (THDI), dodecamethylene diisocyanate, 1,4-diisocyanatocyclohexane, 4,4′-diisocyanato-3,3′-dimethyldicyclohexylmethane, 4,4′-diisocyanatodicyclohexylpropane-(2,2), 3-isocyanatomethyl-1-methyl-1-isocyanatocyclohexane (MCI), 1,3-diisooctylcyanato-4-methylcyclohexane, 1,3-diisocyanato-2-methylcyclohexane and 1,3-bis(2-isocyanatopropan-2-yl)benzene and 1,4-bis(2-isocyanatopropan-2-yl)benzene (m- and p-tetramethylxylylene, TMXDI), toluene 2,4-/2,6-diisocyanate (TDI), methylenediphenyl diisocyanate (MDI), naphthyl diisocyanate (NDI). Preference is given here to using IPDI, HDI, PDI or TDI, or MDI derivatives.

Also included is of course the use, or additional use, of the polymeric polyisocyanates mentioned hereinafter, likewise, for example, in the form of their derivatives, such as urethanes, biurets, allophanates, uretdiones, isocyanurates and trimers and mixed forms of these derivatizations.

In principle, it is also possible to use mixtures of two or more isocyanates, but preference is given to the use of just one isocyanate.

For the synthesis of an isocyanate-functional prepolymer, an excess of the polyisocyanate component is chosen, specifically preferably an NCO:Y—H ratio (Y═O, N or S) of 1.3:1.0 to 5.0:1.0, more preferably of 1.5:1.0 to 3.0:1.0 and most preferably of 1.5:1.0 to 2.5:1.0.

The urethanization may be accelerated by catalysis. Useful urethanization catalysts for accelerating the NCO—OH reaction are those known per se to those skilled in the art such as for example organotin compounds, bismuth compounds, zinc compounds, titanium compounds, zirconium compounds or aminic catalysts.

In the preparation process, this catalyst component, if used, is used in amounts from 0.001% by weight to 5.0% by weight, preferably 0.001% by weight to 0.1% by weight and more preferably 0.005% by weight to 0.05% by weight, based on the solids content of the process product.

The urethanization reaction is conducted at temperatures of 20° C. to 200° C., preferably 40° C. to 140° C. and more preferably of 60° C. to 120° C.

The reaction is continued until (preferably complete) conversion of the isocyanate-reactive groups has been achieved. The progress of the reaction is expediently monitored by checking the NCO content and is ended when the corresponding theoretical NCO content has been reached and is constant. This can be monitored by suitable measuring instruments installed in the reaction vessel and/or using analyses of withdrawn samples. Suitable processes are known to those skilled in the art. These are for example, viscosity measurements, measurements of the NCO content, of the refractive index, of the OH content, gas chromatography (GC), nuclear magnetic resonance spectroscopy (NMR), infrared spectroscopy (IR) and near near-infrared spectroscopy (NIR). The NCO content of the mixture is preferably determined by titrimetric means.

It is unimportant whether the process is conducted continuously, for example in a static mixer, extruder or kneader, or batchwise, for example in a stirred reactor.

The process is preferably conducted in a stirred reactor.

If the conversion of polyisocyanate was incomplete, unreacted polyisocyanate can be removed from the prepolymer by continuous distillation. A continuous distillation process here is understood to be a process in which only a respective part-amount of the prepolymer from the above-described process step is exposed briefly to an elevated temperature, while the quantity not yet part of the distillation procedure remains at a significantly lower temperature. Increased temperature in this case means the temperature which is necessary to evaporate the volatile constituents at an appropriately selected pressure.

The distillation is conducted preferably at a temperature of less than 170° C., more preferably 110 to 170° C., very preferably 125 to 145° C., and at pressures of less than 20 mbar, more preferably less than 10 mbar, very preferably at 0.05 to 5 mbar.

The temperature of the quantity of prepolymer-containing reaction mixture that is not yet within the distillation procedure is preferably 0° to 60° C., more preferably 15° to 40° C. and very preferably 20° to 40° C.

The temperature difference between the distillation temperature and the temperature of that quantity of the prepolymer-containing reaction mixture that is not yet within the distillation procedure is preferably at least 5° C., more preferably at least 15° C., very preferably 15° to 40° C.

The distillation is preferably conducted at a rate such that one volume increment of the prepolymer-containing reaction mixture for distillation is exposed to the distillation temperature for less than 10 minutes, more preferably less than 5 minutes, and subsequently, by active cooling if desired, the temperature is brought to the original temperature of the prepolymer-containing reaction mixture prior to the distillation.

The temperature load traversed in this case is preferably such that the temperature of the reaction mixture before the distillation or of the prepolymer after the distillation is higher than the distillation temperature employed by at least 5° C., more preferably at least 15° C., very preferably at least 15° to 40° C.

Preferred continuous distillation techniques are short-path, falling-film and/or thin-film distillation (in this regard see, for example, Chemische Technik, Wiley-VCH, Volume 1, 5th edition, pages 333-334).

A preferred continuous distillation technique employed is thin-film distillation with the parameters stated above.

A further option is the provision of a silane-functionalized polymeric polyisocyanate having at least one alkoxysilane group as a silane-functional prepolymer which is preferred in accordance with the invention in the context of the second embodiment. Said silane-functionalized polymeric polyisocyanates can be synthesized by the direct reaction of polymeric polyisocyanates with alkoxysilanes which bear an isocyanate-reactive group such as amino, mercapto or hydroxyl. Suitable polymeric polyisocyanates used are aromatic, araliphatic, aliphatic or cycloaliphatic polymeric polyisocyanates having an NCO functionality ≥2. They may also have iminooxadiazinedione, isocyanurate, uretdione, urethane, allophanate, biuret, urea, oxadiazinetrione, oxazolidinone, acylurea and/or carbodiimide structures.

Suitable diisocyanates for preparation of the polymeric polyisocyanates are any diisocyanates which are obtainable by phosgenation or by phosgene-free methods, for example by thermal urethane cleavage, and the isocyanate groups of which are bonded via optionally branched aliphatic radicals to an aromatic system optionally having further substitution, such as preferably butane 1,4-diisocyanate, pentane 1,5-diisocyanate (PDI), hexane 1,6-diisocyanate (hexamethylene diisocyanate, HDI), 4-isocyanatomethyloctane 1,8-diisocyanate (triisocyanatononane, TIN) 4,4′-methylenebis(cyclohexyl isocyanate), 3,5,5-trimethyl-1-isocyanato-3-isocyanatomethylcyclohexane (isophorone diisocyanate, IPDI), methylcyclohexyl 2,4- and/or 2,6-diisocyanate (H₆TDI) and ω,ω′-diisocyanato-1,3-dimethylcyclohexane (HXDI), 4,4′-diisocyanatodicyclohexylmethane, tetramethylene diisocyanate, 2-methylpentamethylene diisocyanate, 2,2,4-trimethylhexamethylene diisocyanate (THDI), dodecamethylene diisocyanate, 1,4-diisocyanatocyclohexane, 4,4′-diisocyanato-3,3′-dimethyldicyclohexylmethane, 4,4′-diisocyanato-2,2-dicyclohexylpropane, 3-isocyanatomethyl-1-methyl-1-isocyanatocyclohexane (MCI), 1,3-diisooctylcyanato-4-methylcyclohexane, 1,3-diisocyanato-2-methylcyclohexane, toluene 2,4-diisocyanate, toluene 2,6-diisocyanate, methylene diphenyl diisocyanate (MDI), naphthyl diisocyanate (NDI), 1,3-bis(isocyanatomethyl)benzene (m-xylylene diisocyanate, m-XDI), 1,4-bis(isocyanatomethyl)benzene (p-xylylene diisocyanate, p-XDI), 1,3-bis(2-isocyanatopropan-2-yl)benzene (m-tetramethylxylylene diisocyanate, m-TMXDI), 1,4-bis(2-isocyanatopropan-2-yl)benzene (p-tetramethylxylylene diisocyanate, p-TMXDI), 1,3-bis(isocyanatomethyl)-4-methylbenzene, 1,3-bis(isocyanatomethyl)-4-ethylbenzene, 1,3-bis(isocyanatomethyl)-5-methylbenzene, 1,3-bis(isocyanatomethyl)-4,5-dimethylbenzene, 1,4-bis(isocyanatomethyl)-2,5-dimethylbenzene, 1,4-bis(isocyanatomethyl)-2,3,5,6-tetramethylbenzene, 1,3-bis(isocyanatomethyl)-5-tert-butylbenzene, 1,3-bis(isocyanatomethyl)-4-chlorobenzene, 1,3-bis(isocyanatomethyl)-4,5-dichlorobenzene, 1,3-bis(isocyanatomethyl)-2,4,5,6-tetrachlorobenzene, 1,4-bis(isocyanatomethyl)-2,3,5,6-tetrachlorobenzene, 1,4-bis(isocyanatomethyl)-2,3,5,6-tetrabromobenzene, 1,4-bis(2-isocyanatoethyl)benzene, 1,4-bis(isocyanatomethyl)naphthalene and any mixtures of these diisocyanates. Especially suitable for preparing said silane-functional polymeric polyisocyanates are dimers of the aforesaid diisocyanates, trimers of the aforesaid diisocyanates, or combinations thereof, as polymeric polyisocyanate of the invention.

The polymeric polyisocyanate components are prepared from the aforementioned diisocyanates with the aid of modification reactions known per se, by reaction of a portion of the isocyanate groups originally present in the starting diisocyanate to form polymeric polyisocyanate molecules consisting of at least two diisocyanate molecules.

Suitable modification reactions of this kind are for example the customary processes for catalytic oligomerization of isocyanates to form uretdione, isocyanurate, iminooxadiazinedione and/or oxadiazinetrione structures or for biuretization of diisocyanates, as described by way of example e.g. in Laas et al., J. Prakt. Chem. 336, 1994, 185-200, in DE-A 1 670 666 and EP-A 0 798 299.

Isocyanate-reactive alkoxysilane compounds for preparation of silane-functionalized prepolymers of the invention (especially silane-functionalized prepolymers of the first and second embodiments) are sufficiently well known to the person skilled in the art. Examples of these include aminopropyltrimethoxysilane, mercaptopropyltrimethoxysilane, mercaptopropyltriethoxysilane, aminopropylmethyldimethoxysilane, mercaptopropylmethyldimethoxysilane, aminopropyltriethoxysilane, mercaptopropyltriethoxysilane, aminopropylmethyldiethoxysilane, mercaptopropylmethyldiethoxysilane, aminomethyltrimethoxysilane, aminomethyltriethoxysilane, (aminomethyl)methyldimethoxysilane, (aminomethyl)methyldiethoxysilane, N-butylaminopropyltrimethoxysilane, N-butylaminopropyltriethoxysilane, N-ethylaminopropyltrimethoxysilan N-ethylaminopropyltriethoxysilane, N-phenylaminopropyltrimethoxysilane, N-phenylaminopropyltriethoxysilane, N,N-bis(3-trimethoxysilylpropyl)amine, N,N-bis(3-triethoxysilylpropyl)amine, N,N-bis(3-tri-i-propoxysilylpropyl)amine.

In addition, isocyanate-reactive alkoxysilane compounds used may also be the aspartic esters as described in EP-A 0 596 360. In these molecules of the general formula III

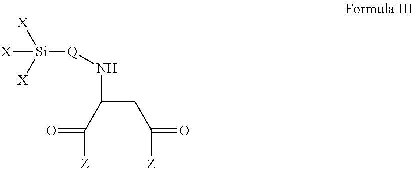

X denotes identical or different alkoxy or alkyl radicals, which may also be bridged, but where there must be at least one alkoxy radical present on each Si atom,
Q is a difunctional linear or branched aliphatic radical and Z is an alkoxy radical having 1 to 10 carbon atoms. The use of such aspartic esters is preferred. Examples of particularly preferred aspartic esters are diethyl N-(3-triethoxysilylpropyl)aspartate, diethyl N-(3-trimethoxysilylpropyl)aspartate and diethyl N-(3-dimethoxymethylsilylpropyl)aspartate.

The prepolymers containing alkoxysilyl groups that are used in the invention are prepared using isocyanate-reactive alkoxysilane compounds, by converting isocyanate-functional prepolymer (preferably that of the first embodiment (isocyanate-functional polyurethane) or of the second embodiment (polymeric polyisocyanates)) by reaction with an isocyanate-reactive alkoxysilane compound to give the silane-terminated prepolymer. Said conversion with isocyanate-reactive alkoxysilanes is effected within a temperature range from 0° C. to 150° C., preferably from 20° C. to 120° C., with the proportions being chosen generally such that 0.8 to 1.3 mol of the isocyanate-reactive alkoxysilane compound are used per mole of NCO groups used, preferably 1.0 mol of isocyanate-reactive alkoxysilane compound per mole of NCO groups used.

In a third embodiment, the silane-functional prepolymer is a silane-functional prepolymer obtainable by the reaction of an isocyanatosilane with a polymer which has functional end groups that are reactive toward isocyanate groups, more particularly hydroxyl groups, mercapto groups and/or amino groups.

Preferred polymers containing functional end groups reactive toward isocyanate groups are the above-stated polymeric polyols, especially polyether, polyester, polycarbonate and polyacrylate polyols, and also polyurethane polyols, prepared from polyisocyanates and the stated polyols. It is also possible to use mixtures of all stated polyols.

Suitable isocyanate-functional alkoxysilane compounds are in principle all monoisocyanates containing alkoxysilane groups and having a molecular weight of 140 g/mol to 500 g/mol. Examples of such compounds are isocyanatomethyltrimethoxysilane, isocyanatomethyltriethoxysilane, (isocyanatomethyl)methyldimethoxysilane, (isocyanatomethyl)-methyldiethoxysilane, 3-isocyanatopropyltrimethoxysilane, 3-isocyanatopropylmethyl-dimethoxysilane, 3-isocyanatopropyltriethoxysilane and 3-isocyanatopropylmethyl-diethoxysilane. Preference is given here to the use of 3-isocyanatopropyltrimethoxysilane or 3-isocyanatopropyltriethoxysilane; especially preferred is the use of 3-isocyanatopropyltriethoxysilane.

It is also possible in accordance with the invention to use isocyanate-functional silanes which have been prepared by reaction of a diisocyanate with an aminosilane or thiosilane, as described in U.S. Pat. No. 4,146,585 or EP-A 1 136 495.

The reaction of the isocyanatosilanes with the polyols that are used with preference is effected in the same way as described above for the preparation of the isocyanate-containing prepolymer, from the polyisocyanate component with the polyol component.

The ratio of the NCO groups in the isocyanatosilane to the isocyanate-reactive groups, preferably the hydroxyl groups of the polyols, is between 0.5:1 and 1:1, preferably between 0.75:1 and 1:1, most preferably between 0.9:1 and 1:1.

In a fourth embodiment the silane-functional prepolymer is a silane-functional prepolymer obtainable by a hydrosilylation reaction of polymers having terminal double bonds, examples being poly(meth)acrylate polymers and polyether polymers, more particularly of allyl-terminated polyoxyalkylene polymers, described for example in U.S. Pat. Nos. 3,971,751 and 6,207,766.

In addition, it is also possible in accordance with the invention to use those alkoxysilane-containing prepolymers that are described in the published specifications cited in the introduction to this patent application.

Suitable commercially available silane-functional prepolymers covered by the preceding description are especially products available under the trade names MS Polymer™ (from Kaneka Corp.; especially types S203H, S303H, S227, S810, MA903 or S943); MS Polymer™ or SilyI™ (from Kaneka Corp.; especially types SAT010, SAT030, SAT200, SAX350, SAX400, SAX725, MAX450, MAX602 or MAX951); Excestar® (from Asahi Glass Co. Ltd.; especially types S2410, S2420, S3430 or S3630); SPUR+® (from Momentive Performance Materials; especially types 101 OLM, 1015LM or 1050MM); Vorasil™ (from Dow Chemical Co.; especially types 602 or 604); Desmoseal® (from Covestro Deutschland AG; especially the types S XP 2458, XP 2636, S XP 2749, S XP 2774 or S XP 2821); TEGOPAC® (from Evonik Industries AG; especially the types Seal 100, Bond 150 or Bond 250); or Geniosil® STP (from Wacker Chemie AG; especially types E15 or E35, E10 and E-30).

The composition of the invention preferably contains component A in an amount of 5% to 95% by weight, more preferably of 10% to 80% by weight, most preferably of 10% to 50% by weight, based in each case on the total weight of the composition.

In addition, the composition of the invention comprises at least one amino-functional compound that acts as aging stabilizer (component B), excluding compounds of the oxalanilide type and compounds having 2,2,6,6 tetramethylpiperidinyl groups from component B.

These are preferably amino-functional compounds that have at least one secondary amino group in which at least one of the radicals is an aryl radical optionally substituted by alkyl, aralkyl, secondary amino (—N(H)-alkyl) or tertiary amino groups (—N(alkyl¹)-alkyl²), preferably a phenyl radical optionally substituted by alkyl, aralkyl, secondary amino (—N(H)-alkyl) or tertiary amino groups (—N(alkyl¹)-alkyl²); excluding compounds of the abovementioned component B type.

These include, for example, the amino-functional compounds of the following general formulae IV to VI:

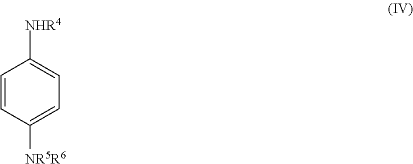

where R⁴ is a saturated or unsaturated, linear or branched, aliphatic or cycloaliphatic radical, or an optionally substituted aromatic or araliphatic radical, having up to 18 carbon atoms; and R⁵ and R⁶ are identical or different radicals and are hydrogen, a saturated or unsaturated, linear or branched, aliphatic or cycloaliphatic radical, or an optionally substituted aromatic or araliphatic radical having up to 18 carbon atoms, and where R⁵ is preferably hydrogen.

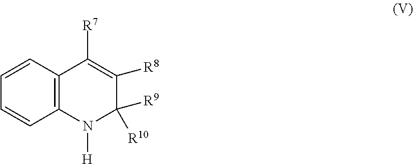

where the R⁷ to R¹⁰ radicals are identical or different radicals and are hydrogen, a saturated or unsaturated, linear or branched, aliphatic or cycloaliphatic radical, or an optionally substituted aromatic or araliphatic radical, having up to 18 carbon atoms, and are preferably identical or different radicals and are hydrogen or a saturated or unsaturated, linear or branched aliphatic radical having up to 6 carbon atoms.

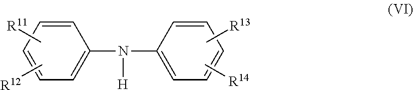

where the R¹¹ to R¹⁴ radicals are identical or different radicals and are hydrogen, a saturated or unsaturated, linear or branched, aliphatic or cycloaliphatic radical, or an optionally substituted aromatic or araliphatic radical, having up to 18 carbon atoms, or the R¹¹ and R¹² radicals and/or the R¹³ and R¹⁴ radicals are bonded in each case to the aromatic system(s) in ortho positions to one another and together form an aromatic, optionally substituted ring. Preferably, at least one of the R¹¹ and R¹³ radicals, more preferably both R¹¹ and R¹³ radicals, are hydrogen, and the respective other radicals are independently a saturated or unsaturated, linear or branched, aliphatic or cycloaliphatic radical, or an optionally substituted aromatic or araliphatic radical, having up to 18 carbon atoms.

The compounds of the general formulae IV to VI include, for example: 2,2,4-trimethyl-1,2-dihydroquinoline (TMQ), N,N′-bis-(1,4-dimethylpentyl)-p-phenylenediamine, N-isopropyl-N′-phenyl-p-phenylenediamine, N-(1,3-dimethylbutyl)-N′-phenyl-p-phenylenediamine, N-phenyl-1-naphthylamine, N-phenyl-1-naphthylamine, bis(4-octylphenyl)amine (also octylated diphenylamine) and styrenized diphenylamine.

More preferably, the at least one amino-functional compound is selected from compounds of the general formulae IV and V.

Even more preferably, the at least one amino-functional compound is selected from 2,2,4-trimethyl-1,2-dihydroquinoline (TMQ), N,N-bis(1,4-dimethylpentyl)-p-phenylenediamine, N-isopropyl-N′-phenyl-p-phenylenediamine, and N-(1,3-dimethylbutyl)-N′-phenyl-p-phenylenediamine.

Most preferably, the at least one amino-functional compound is selected from 2,2,4-trimethyl-1,2-dihydroquinoline (TMQ) and N-(1,3-dimethylbutyl)-N′-phenyl-p-phenylenediamine.

The composition of the invention preferably contains component B in an amount of 0.01% to 2% by weight, more preferably of 0.1% to 1% by weight, even more preferably of 0.1% to 0.5% by weight, based in each case on the total weight of the composition.

Component B can be added to the formulation as a single component. Typically, aging stabilizers, light stabilizers and UV stabilizers are added as a package to most STP-based formulations. Furthermore, component B may also already be added to the STP as a stabilizer during the production thereof.

In one embodiment, the composition of the invention additionally comprises at least one curing catalyst (component C). This serves as catalyst for the crosslinking of the silane-functional prepolymers and further compounds containing silane groups.

Catalysts of this kind that are used may be any of the known compounds capable of catalyzing the hydrolytic cleavage of the hydrolyzable groups of the organosilane groups and the subsequent condensation of the Si—OH group to siloxane groups.

Suitable curing catalysts are, for example, titanates, such as tetrabutyl titanate or titanium tetraacetylacetonate; bismuth compounds such as bismuth tris-2-ethylhexanoate; tin carboxylates such as dibutyltin dilaurate (DBTL), dibutyltin diacetate or dibutyltin diethylhexanoate; tin oxides such as dibutyltin oxide and dioctyltin oxide; organoaluminum compounds such as aluminum trisacetylacetonate; chelate compounds such as zirconium tetraacetylacetonate; amine compounds or salts thereof with carboxylic acids, such as octylamine, cyclohexylamine, benzylamine, dibutylamine, monoethanolamine, triethanolamine, diethylenetriamine, triethylenetetramine, triethylenediamine, 1,8-diazabicyclo[5.4.0]undec-7-ene (DBU), 1,5-diazabicyclo[4.3.0]non-5-ene (DBN), 6-(dibutylamino)-1,8-diazabicyclo[5.4.0]undec-7-ene, N-methyltriazabicyclodecene, tetramethylguanidine, 2-guanidinobenzimidazole, acetylacetoneguanidine, 1,3-di-o-tolylguanidine (DTG), 1,3-diphenylguanidine, o-tolylbiguanidine, 2-tert-butyl-1,1,3,3-tetramethylguanidine or N-(3-triethoxysilylpropyl)-4,5-dihydroimidazole, N-(3-trimethoxysilylpropyl)-4,5-dihydroimidazole, guanidine, morpholine, N-methylmorpholine.

Particular preference is given to using 1,8-diazabicyclo[5.4.0]undec-7-ene (DBU) and/or 1,5-diazabicyclo[4.3.0]non-5-ene (DBN).

One embodiment works without metal catalysts; another uses catalysts that do not contain heavy metals such as Sn.

If catalysts are employed, the composition of the invention preferably comprises 0.01% to 5% by weight, preferably 0.05% to 2.5% by weight, more preferably 0.1% to 1% by weight, of curing catalyst based on the total weight of the composition.

In one embodiment, no catalyst is employed. However, the use of catalysts is preferred.

In addition, the composition of the invention optionally comprises additives and/or auxiliaries (component D). These include:
i) Fillers: Suitable fillers are inorganic and organic fillers, for example natural, ground or precipitated calcium carbonates that are optionally coated with fatty acids, especially stearic acid, barium sulfate (BaSO₄, also called barite or heavy spar), calcined kaolins, aluminum oxides, aluminum hydroxides, magnesium hydroxide, silicas, especially finely divided silicas from pyrolysis processes, carbon blacks, especially industrially produced carbon black, PVC powders or hollow beads. Preferred fillers are calcium carbonates, calcined kaolins, carbon black, finely divided silicas and flame-retardant fillers (cf. also v)).

The composition of the invention comprises preferably 2% to 80% by weight, preferably 40% to 70% by weight, more preferably 50% to 60% by weight, of filler, based on the total weight of the composition.
ii) Plasticizers: Suitable plasticizers are, for example, esters of organic carboxylic acids or anhydrides thereof, such as phthalate, for example dioctyl phthalate, diisononyl phthalate or diisodecyl phthalate, adipates, for example dioctyl adipate, azelates and sebacates, dialkyl cyclohexanedicarboxylates in which the alkyl radicals of the ester groups each independently contain 1 to 20 carbon atoms, polyols, for example polyoxyalkylene polyols or polyester polyols, organic phosphorus and sulfonic esters, or polybutenes. If no other constituent contains polymers having polyether groups, preference is given to using at least one polymer having polyether groups as plasticizer.

The composition of the invention comprises preferably 0% to 30% by weight, preferably 5% to 20% by weight, more preferably 7.5% to 15% by weight, of plasticizer, based on the total weight of the composition. iii) Desiccants: Suitable desiccants are, for example, vinyltrimethoxysilane, cc-functional silanes such as N-(silylmethyl)-O-methyl carbamates, especially N-(methyldimethoxysilylmethyl)-O-methyl carbamate, (methacryloyloxymethyl)silanes, methoxymethylsilanes, N-phenyl-, N-cyclohexyl- and N-alkylsilanes, orthoformic esters, calcium oxide or molecular sieves. The desiccant used is preferably a vinyl-modified organosilane, for example vinyltrimethoxysilane or vinyltriethoxysilane. In a particular embodiment in which the silane groups present in the composition are essentially ethoxysilane groups, preference is given to vinyltriethoxysilane.

The composition of the invention comprises preferably 0.1% to 10% by weight, preferably 0.5% to 7% by weight, more preferably 0.5% to 5% by weight, most preferably 0.8% to 3% by weight, of desiccant, based on the total weight of the composition.
iv) Adhesion promoter and/or crosslinker: These are, for example, silanes such as, in particular, aminosilanes, such as, in particular, 3-aminopropyltrimethoxysilane, 3-aminopropyldimethoxymethylsilane, N-(2-aminoethyl)-3-aminopropyltrimethoxysilane, N-(2-aminoethyl)-3-aminopropylmethyldimethoxysilane, N-(2-aminoethyl)-N′-[3-(trimethoxysilyl)propyl]ethylenediamine or analogs thereof with ethoxy or isopropoxy groups instead of the methoxy groups on the silicon, N-phenyl-, N-cyclohexyl- or N-alkylaminosilanes, also mercaptosilanes, epoxysilanes, (meth)acryloylsilanes, anhydridosilanes, carbamatosilanes, alkylsilanes, vinylsilanes or iminosilanes, or oligomeric forms of these silanes or adducts of primary aminosilanes with epoxysilanes or (meth)acryloylsilanes or anhydridosilanes. 3-Glycidoxypropyltrimethoxysilane, 3-aminopropyltrimethoxysilane, N-(2-aminoethyl)-3-aminopropyltrimethoxysilane, N-(2-aminoethyl)-N′-[3-(trimethoxysilyl)propyl]ethylenediamine, 3-mercaptopropyltrimethoxysilane, 3-ureidopropyltrinnethoxysilane, vinyltrimethoxysilane or the corresponding silanes with ethoxy groups instead of the methoxy groups or oligomeric forms of these silanes are especially suitable.
v)—Further stabilizers, for example UV stabilizers, UV absorbers, HALS amines or phenolic antioxidants.
   Solvents.
   Pigments, especially titanium dioxide or iron oxides.
   Rheology modifiers, especially thickeners.
   Sheet silicates such as bentonites, derivatives of castor oil, hydrogenated castor oil, polyamides, polyurethanes, urea compounds, fumed silicas, cellulose ethers or hydrophobically modified polyoxyethylenes.
   Fibers, in particular glass fibers, carbon fibers, metal fibers, ceramic fibers or plastic fibers such as polyamide fibers or polyethylene fibers.
   Dyes.
   Natural resins, fats or oils such as rosin, shellac, linseed oil, castor oil or soybean oil.
   Nonreactive polymers, such as, in particular, homo- or copolymers of unsaturated monomers, especially from the group comprising ethylene, propylene, butylene, isobutylene, isoprene, vinyl acetate or alkyl (meth)acrylates, especially polyethylenes (PE), polypropylenes (PP), polyisobutylenes,
   Ethylene vinyl acetate copolymers (EVA) or atactic poly-a-olefins (APAO).
   Flame-retardant substances, especially the abovementioned fillers aluminum hydroxide or magnesium hydroxide, or especially organic phosphoric esters, such as, in particular, triethyl phosphate, tricresyl phosphate, triphenyl phosphate, diphenyl cresyl phosphate, isodecyldiphenyl phosphate, tris(1,3-dichloro-2-propyl) phosphate, tris(2-chloroethyl) phosphate, tris(2-ethylhexyl) phosphate, tris(chloroisopropyl) phosphate, tris(chloropropyl) phosphate, isopropylated triphenyl phosphate, mono-, bis- or tris(isopropylphenyl) phosphates of different degrees of isopropylation, resorcinol bis(diphenyl phosphate), bisphenol A bis(diphenyl phosphate) or ammonium polyphosphates.
   Surface-active substances, especially wetting agents, leveling agents, deaerating agents or defoamers.
   Biocides, especially algicides, fungicides or substances that inhibit fungal growth.
   Further substances commonly used in moisture-curing compositions.

It may be advantageous to dry certain constituents by chemical or physical means before incorporation into the composition.

The composition of the invention preferably contains at least one further constituent selected from fillers, crosslinkers, plasticizers, solvents, catalysts, adhesion promoters, drying agents, stabilizers, pigments and rheology aids as described hereinabove.

The composition is preferably produced and stored in the absence of moisture. The composition is typically storage stable in the absence of moisture in a suitable packaging or configuration, such as especially a drum, a bag or a cartridge.

The composition may be in the form of a one-component composition or in the form of a two-component composition.

In the present document “one-component” is to be understood as referring to a composition in which all constituents of the composition are stored mixed together in the same container and which is moisture-curable.

The term “curable” generally means in particular that the composition is capable of conversion from a relatively flexible, optionally plastically deformable state into a harder state under the influence of external conditions, in particular under the influence of moisture present in the environment and/or intentionally supplied. The crosslinking can generally be effected through chemical and/or physical influences in addition to the moisture already mentioned, i.e., for example, also through supply of energy in the form of heat, light or other electromagnetic radiation, but also by simple contacting of the composition with air or a reactive component.

In the present document “two-component” is to be understood as referring to a composition in which the constituents of the composition are in two different components which are stored in separate containers.

Shortly before or during application of the composition the two components are mixed with one another to cure the mixed composition, wherein the curing is only effected or completed through the action of moisture.

During application of the composition on at least one object or article the silane groups present and any further moisture-curing groups present come into contact with moisture, thus curing the composition. The curing occurs at different rates according to temperature, type of contact, the amount of moisture and the presence of any catalysts. In the case of curing by means of atmospheric humidity a skin is initially formed at the surface of the composition. The so-called skin forming time is a measure of the curing rate.

A further aspect of the invention is a cured composition as obtainable by curing of an above-described moisture-curing composition.

In the cured state the composition exhibits highly elastic properties, in particular a high strength and a high extensibility, and also good heat resistance and good adhesion properties on a very wide variety of substrates. This makes it suitable for a multiplicity of uses, in particular as a fiber composite material, potting compound, sealant, adhesive, covering, coating or paint for construction and industrial applications, for example as an electrical insulation compound, filler compound, joint sealant, welding or flanged seam sealant, parquet adhesive, assembly adhesive, autobody adhesive, window adhesive, sandwich element adhesive, floor covering, floor coating, balcony coating, roof coating, concrete protective coating, parking garage coating or as a protective coating against corrosion, as a sealant, paint, lacquer or primer. It is particularly suitable as an adhesive or sealant or coating, in particular for joint sealing or for elastic adhesive joins in construction or industrial applications.

The invention further relates to the use of a moisture-curing composition as described above and/or of the cured composition as described above as sealant, adhesive or coating material.

For use as an adhesive or sealant, the moisture-curing composition preferably has a pasty consistency with pseudoplastic properties. Such a pasty adhesive or sealant is applied to a substrate, optionally using an application robot, in particular from commercially available cartridges operated manually or using compressed air or from a drum or hobbock using a conveying pump or an extruder.

It is possible to bond or seal two identical or two different substrates.

Suitable substrates are especially:
glass, glass ceramic, screen printed ceramic, concrete, mortar, brick, tile, gypsum or natural stone such as granite or marble;
metals or alloys, such as aluminum, iron, steel or non-ferrous metals, or surface-coated metals or alloys, such as galvanized or chromed metals;
leather, textiles, paper, wood, with resins, for example phenolic, melamine or epoxy resins, bound wood-based materials, resin-textile composites or further so-called polymer composites;
plastics, in particular unplasticized or plasticized PVC, ABS, polycarbonate (PC), polyamide (PA), polyester, PMMA, epoxy resins, PUR, POM, PO, PE, PP, EPM or EPDM, wherein the plastics are optionally surface treated using plasma, corona or flame treatments;
fiber reinforced plastics, such as carbon fiber reinforced plastics (CFRP), glass fiber reinforced plastics (GFRP) or sheet molding compounds (SMC);
coated substrates, such as powder-coated metals or alloys;
paints or varnishes, especially automotive topcoats.

If desired the substrates may be pretreated before application of the adhesive or sealant, in particular through physical and/or chemical cleaning processes or application of an adhesion promoter, an adhesion promoter solution or a primer.

After the bonding or sealing of two substrates a glued or sealed article is obtained. Such an article may be a built structures, in particular a high-rise or low-rise built structures, or an industrial good or a consumer good, in particular a window, a household machine or a means of transport such as in particular an automobile, a bus, a heavy goods vehicle, a rail vehicle, a ship, an airplane or helicopter or an attachment thereof.

The adhesives, sealants and coatings obtainable using the compositions of the invention are withstand much higher temperatures than the known STP-based systems from the prior art, and can therefore be used in sectors where they are exposed to elevated temperatures, i.e. temperatures above 100° C., for a long period of time. For example, the coatings, adhesive bonds or seals of the invention find use in the construction sector, for example in roof lining, as facade sealant, as anticorrosive coating, pipeline coating or industrial coating, in the automotive sector, or in the solar technology or electronics sector.

### EXAMPLES

The present invention is more particularly elucidated with reference to the following examples without, however, being limited thereto.

Methods and Materials:

Adhesive formulations were produced without aging stabilizer, with aging stabilizer according to the prior art, and with the aging stabilizers of the invention.

Viscosity and reactivity of the freshly produced mixture was determined 7 days after dispensing into cartridges (storage at 23° C.). The cartridges were stored at 50° C. for 12 weeks, and the change in viscosity and reactivity was determined.

Likewise 7 days after dispensing, a membrane is produced and is cured under standard conditions (23° C./50% rel. humidity) for 2 weeks.

The physical properties (hardness, tensile strength, stress value, elongation at break) were first measured on unaged test specimens.

Aging resistance was determined by subjecting the membranes to a temperature of 90° C. in an air circulation oven for up to 33 weeks. Test specimens were produced again from the aged membranes, and the physical properties (hardness, tensile strength, stress value, elongation at break) were determined. Good aging resistance is apparent by a small change in physical values after storage at 90° C.

The thermal stability of the STP formulations was effected by measuring oxidation induction time (OIT) by dynamic differential calorimetry to DIN EN ISO 11357-6:2013 determined. A high OIT indicates high thermal stability.

Reactants used in the examples:

TABLE 1

| Name | Description | Manufacturer |
|---|---|---|
| Desmoseal ® S XP 2458 | Aliphatic silane-terminated | Covestro |
| Desmoseal ® S XP 2636 | polyurethane polymer | Deutschland AG |
| Mesamoll ®, | Plasticizer | Lanxess AG |
| Jayflex ® DINP | Plasticizer | Exxon |
| Cab-O-Sil ® TS 720 | Rheology additive | Cabot Corporation |
| Omyalite ® 95T | Filler | Omya AG |
| Dynasylan ® VTMO | Desiccant | Evonik Industries AG |
| Dynasylan ® 1146 | Adhesion promoter | Evonik Industries AG |
| Vulkanox ® HS | Aging stabilizer based on | Lanxess AG |
| | 2,2,4-trimethyl-1,2- | |
| | dihydroquinoline | |
| Vulkanox ® 4020 | Aging stabilizer based on N-(1,3- | Lanxess AG |
| | dimethylbutyl)-N′-phenyl-p- | |
| | phenylenediamine | |
| Irganox ®1135 | Phenolic aging stabilizer | BASF SE |
| Tinuvin ® 1130 | UV absorber | |
| Tinuvin ® 292 | Light stabilizer | |
| DBU, (1,8- | Catalyst | Sigma - Aldrich |
| diazabicyclo[5.4.0]undec-7-ene) | | Corporation |

Production of Moisture-Curing Formulations Based on Silane-Terminated Polymers (Adhesive Example)

A moisture-curing adhesive composition based on a silane-modified polymer was produced by the following method: 2817 g of Omyalite® 95 T filler (calcium carbonate, from Omya AG) that has been dried beforehand in an air circulation drying cabinet at 100° C. for 16 hours is dispersed together with 519.5 g of plasticizer (Mesamoll®, from Lanxess AG), 1501 g of Desmoseal® S XP 2458 (aliphatic silane-terminated polyurethane polymer, from Covestro Deutschland AG), 41.5 g of Cab-O-Sil® TS 720 (hydrophobic fumed silica, from Cabot Corporation), 0-23 g of aging stabilizer (and optionally further UV/light stabilization additives) and 6 g of 1,8-diazabicyclo[5.4.0]undec-7-ene (catalyst, Sigma-Aldrich Corporation), and 115 g of desiccant (Dynasylan® VTMO, vinyltrimethoxysilane, from Evonik Industries AG) in a laboratory dissolver with a butterfly stirrer (200 rpm) and dissolver disk (2500 rpm) under static vacuum and cooling for 15 min.

The adhesive composition was then mixed in a laboratory dissolver having a dissolver disk (1000 rpm) with an aminosilane under static vacuum for 5 min and then under dynamic vacuum (20 mbar) for 5 min.

The production of the mixture was conducted with cooling, such that the temperature did not exceed 65° C. during the production.

What is meant here by static vacuum is that the apparatus is evacuated down to a pressure of 20 mbar (dynamic vacuum) and then the connection to the vacuum pump is severed.

A comparative experiment was conducted without aging stabilizer and mixtures with the different aging stabilizers in different dosage.

TABLE 2

| | | Stabilizer in |
|---|---|---|
| Example | Stabilizer | % by wt. |
| 1.0 | No ASM | 0 |
| 2.1/3.1 | Irganox ® 1135 | 0.4 |
| 1.1 | Irganox ® 1135 | 0.1 |
| 2.2/3.2 | Vulkanox ® HS/LG | 0.4 |
| 1.2 | Vulkanox ® HS/LG | 0.1 |
| 2.3/3.3 | Vulkanox ® 4020/LG | 0.4 |
| 1.3 | Vulkanox ® 4020/LG | 0.1 |

The adhesive compositions obtained by the method described above were dispensed into cartridges and stored at room temperature (23° C.) for 7 days. Then the formulations were tested a) in liquid form and b) in cured form.

Test Methods/Tests on the Liquid System

The storage stability of the moisture-curing adhesive compositions was verified in cartridges heated to 50° C. (viscosity). Viscosity was measured on the Anton Paar Physica MCR 501 instrument. The CP 25/1 cone/plate with CPTD-200 Peltier heating was used.
Measurement profile: d(gamma)/dt=0.1 . . . 100 l/s log; Islopel=8 pts./dec; T=23° C.

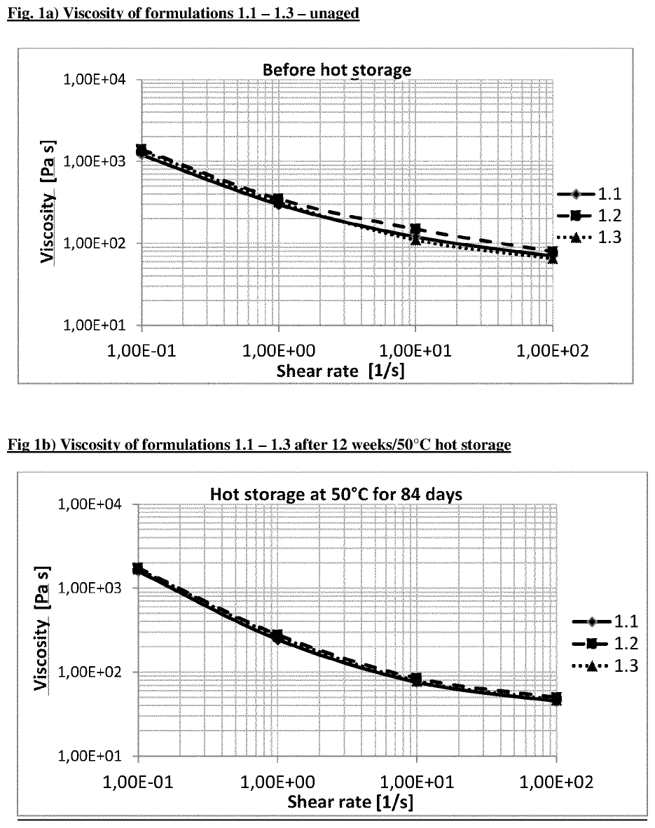

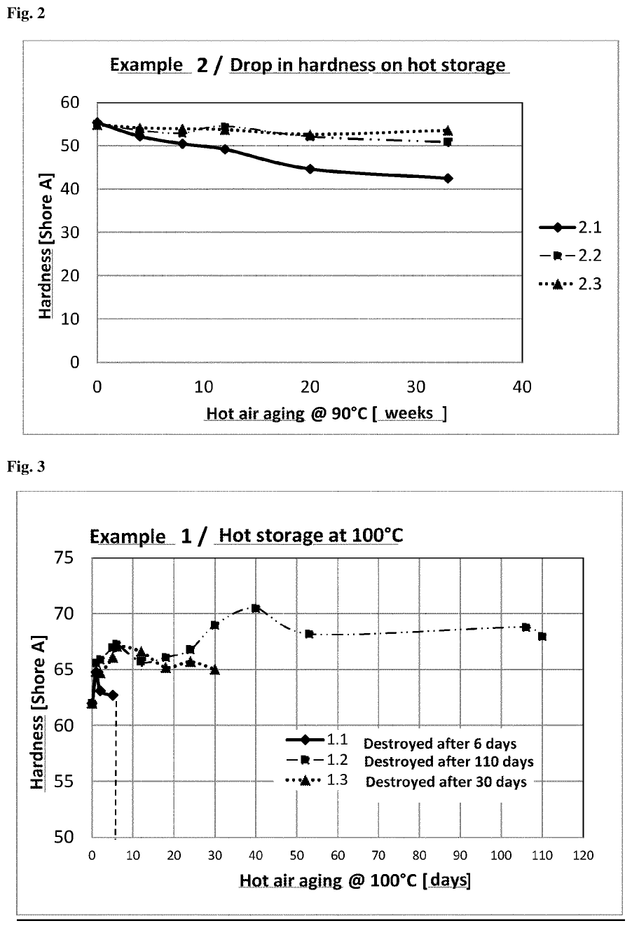

The change in viscosity as a function of shear rate for examples 1.1, 1.2 and 1.3 after a) storage at RT for 7 days and b) after storage at 50° C. for a further 84 days is shown in FIGS. 1 a) and 1b) respectively.

### Example 1

TABLE 3

| Example | 1.1 | 1.2 | 1.3 |
|---|---|---|---|
| Desmoseal S XP 2458 | 29.36 | 29.36 | 29.36 |
| Mesamoll | 10.46 | 10.46 | 10.46 |
| Irganox 1135 | 0.1 | | |
| Vulkanox HS/LG | | 0.1 | |
| Vulkanox 4020/LG | | | 0.1 |
| Cab-O-Sil TS 720 | 0.81 | 0.81 | 0.81 |
| Omyalite 95T | 55.35 | 55.35 | 55.35 |
| Dynasilan VTMO | 2.26 | 2.26 | 2.26 |
| DBU (1,8-diazabicyclo[5.4.0]undec-7-ene) | 0.1 | 0.1 | 0.1 |
| Dynasilan 1146 | 1.54 | 1.54 | 1.54 |

The use of different aging stabilizers does not show any significant effects on the viscosity of the moisture-curing adhesive compositions.

### Example 2

The mixture is produced as described above.

TABLE 4

| | 2.1 | 2.2 | 2.3 |
|---|---|---|---|
| | Irganox 1135 | Vulkanox HS | Vulkanox 4020 |
| Desmoseal S XP 2636 | 26.2 | 26.2 | 26.2 |
| JayflexDINP | 13.0 | 13.0 | 13.0 |
| Irganox 1135 | 0.4 | — | — |
| Vulkanox HS | — | 0.4 | — |
| Vulkanox 4020 | — | — | 0.4 |
| Tinuvin 1130 | 0.3 | 0.3 | 0.3 |
| Tinuvin 292 | 0.4 | 0.4 | 0.4 |
| Cab-O-Sil TS 720 | 0.81 | 0.81 | 0.81 |
| Omyalite 95T | 55.0 | 55.0 | 55.0 |
| Dynasilan VTMO | 2.26 | 2.26 | 2.26 |
| DBU | 0.12 | 0.12 | 0.12 |
| Dynasilan 1146 | 1.51 | 1.51 | 1.51 |

### Example 3

TABLE 5

| | 3.1 | 3.2 | 3.3 |
|---|---|---|---|
| | Irganox 1135 | Vulkanox HS | Vulkanox 4020 |
| Desmoseal S XP 2458 | 32.3 | 32.3 | 32.3 |
| JayflexDINP | 0.99 | 0.99 | 0.99 |
| Irganox 1135 | 0.4 | — | — |
| Vulkanox HS | — | 0.4 | — |
| Vulkanox 4020 | — | — | 0.4 |
| Tinuvin 1130 | 0.4 | 0.4 | 0.4 |
| Tinuvin 292 | 0.3 | 0.3 | 0.3 |
| Omyalite 95T | 61.35 | 61.35 | 61.35 |
| Dynasilan VTMO | 2.5 | 2.5 | 2.5 |
| DBU | 0.06 | 0.06 | 0.06 |
| Dynasilan 1146 | 1.7 | 1.7 | 1.7 |

TABLE 6

| | Irganox 1135 | Vulkanox HS | Vulkanox 4020 |
|---|---|---|---|
| Example | 2.1 | 2.2 | 2.3 |
| Film drying time, h:min | 2:35 | 2:35 | 2:25 |
| Example | 3.1 | 3.2 | 3.3 |
| Film drying time, h:min | 1:40 | 1:35 | 1:40 |

The viscosity and reactivity (measured as film drying time with a drying recorder according to DIN ISO 14022:2010-06) of the formulations are not significantly affected by the different aging stabilizers.

a) Test Methods/Tests on the Cured System

The physical properties were determined by producing membranes of thickness 2 mm. For this purpose, with the aid of a coating bar, the formulation was applied to give membranes having a uniform layer thickness of 2 mm on a polyethylene film and cured at 23° C. and 50% humidity for 14 days, in the course of which the membranes were detached from the film and turned over after 7 days. Subsequently, the physical properties and, on that basis, the aging stability of the resultant membranes were determined by the following methods:

Tensile strength, elongation at break and stress value at 100% elongation to DIN EN 53504.

Shore A hardness to DIN 53505. For this purpose, 3 membranes were placed one on top of another in order to achieve the standard layer thickness of 6 mm.

TABLE 7

| | Irganox 1135 | Vulkanox HS | Vulkanox 4020 |
|---|---|---|---|
| | 2.1 | 2.3 | 2.3 |
| Hardness, Shore A | 55.4 | 55.2 | 54.9 |
| Tensile strength, | 2.67 | 2.8 | 2.74 |
| N/mm² | | | |
| Elongation at break, % | 339 | 351 | 364 |
| 100% stress value, | 1.66 | 1.70 | 1.76 |
| N/mm² | | | |

TABLE 8

| | Irganox 1135 | Vulkanox HS | Vulkanox 4020 |
|---|---|---|---|
| | 3.1 | 3.2 | 3.3 |
| Hardness, Shore A | 69 | 72 | 66 |
| Tensile strength, | 4.1 | 3.9 | 4.1 |
| N/mm² | | | |
| Elongation at break, % | 126 | 100 | 136 |
| 100% stress value, | 4 | 3.9 | 4 |
| N/mm² | | | |

The physical properties of the unaged test specimens are virtually the same, irrespective of the aging stabilizer used.

b) Test Methods/Tests of Oxidation/Aging Stability

The accelerated aging test used was a DSC OIT experiment. Oxidation induction time (OIT) was determined by a DSC experiment in a Pyris-1 calorimeter (from Perkin-Elmer). Pieces weighing about 7 mg were cut out of the membranes to be examined with a hole punch. The samples, without preconditioning, were heated up to storage temperature 170° C. at a high heating rate (200 K/min) in a calorimeter and stored in pure oxygen for 180 minutes.

The OIT is the juncture at which an exothermic oxidation reaction sets in.

TABLE 9

| | Irganox 1135 | Vulkanox HS | Vulkanox 4020 |
|---|---|---|---|
| | 2.1 | 2.2 | 2.3 |
| DCS OIT, min | 58.7 | >180 | >180 |

TABLE 10

| | Irganox 1135 | Vulkanox HS | Vulkanox 4020 |
|---|---|---|---|
| | 3.1 | 3.2 | 3.3 |
| DSC OIT | 69.6 | >180 | >180 |

Inventive examples 2.2, 2.3, 3.2 and 3.3, with an oxidation induction time of >180 minutes, have the highest thermal stability, meaning that the samples were not destroyed during the experiment. The samples with a prior art aging stabilizer are destroyed after 59 min and 69 min.

A sample without aging stabilizer is destroyed after only 4 min in this test.

Stability with Heated Storage

The cured adhesive, sealant or coating compositions were stored in the form of a membrane of thickness 2 mm in an air circulation oven at 90° C. over a period of up to 33 weeks. The physical properties were tested at regular intervals. Every 7 days, the membranes were taken out of the air circulation cabinet and cooled down, and test specimens were punched out.

Prior art formulation 2.1 shows a distinct drop in Shore A hardness. The Shore A hardness of inventive formulations 2.2 and 2.3 is virtually unchanged after heated storage for about 20 weeks.

Membranes of the formulations from example 1 were aged in an air circulation oven at 100° C. The prior art formulation was destroyed after 6 days. The inventive formulations had a lifetime of 30 days and 110 days.

1. A method for age stabilizing composition comprising at least one silane-functional prepolymer having at least one alkoxysilane group comprising providing an amino-functional compound, excluding compounds of the oxalanilide type and compounds having 2,2,6,6 tetramethylpiperidinyl groups.

2. A composition comprising or consisting of:
A) at least one silane-functional prepolymer having at least one alkoxysilane group,
B) at least one amino-functional compound that acts as aging stabilizer, excluding compounds of the oxalanilide type and compounds having 2,2,6,6 tetramethylpiperidinyl groups from component B,
C) optionally a catalyst component, and
D) optionally additives and/or auxiliaries, excluding aging stabilizers that are covered by the definition of component B.

3. The composition as claimed in claim 2, wherein the at least one silane-functional prepolymer is selected from the list of prepolymers formed by polyurethanes having at least one alkoxysilane group, polymeric polyisocyanates having at least one alkoxysilane group, polymeric polyols having at least one alkoxysilane group, polyether polyols having at least one alkoxysilane group, polyester polyols having at least one alkoxysilane group, polycarbonate polyols having at least one alkoxysilane group, polyacrylate polyols having at least one alkoxysilane group, polymethacrylate polyols having at least one alkoxysilane group and polyurethane polyols having at least one alkoxysilane group.

4. The composition as claimed in claim 2, wherein the at least one silane-functional prepolymer having at least one alkoxysilane group has a number-average molecular weight Mn of not more than 30 000 g/mol.

5. The composition as claimed in claim 2, wherein the at least one silane-functional prepolymer has at least one alkoxysilane group of the general formula (I)
*—R³—Si(R¹)₃₋ₐ(OR²)ₐ (I)
where
R¹ is an alkyl group having 1 to 8 carbon atoms;
R² is an alkyl group having 1 to 12 carbon atoms;
R³ is a linear or branched, optionally cyclic, alkylene group having 1 to 18 carbon atoms, optionally having aromatic moieties, and optionally having one or more heteroatoms;
a has a value of 1 or 2 or 3; and
* represents an unoccupied valence of the radical/structure fragment identified thereby to which the prepolymer binds.

6. The composition as claimed in claim 2, wherein the alkoxy radicals of the alkoxysilane groups of the at least one silane-functional prepolymer are methoxy and/or ethoxy groups.

7. The composition as claimed in claim 2, wherein an alkoxysilane group binds to each termini of the at least one silane-functional prepolymer.

8. The composition as claimed in claim 2, wherein the at least one amino-functional compound that acts as aging stabilizer has at least one secondary amino group in which at least one of the radicals is an aryl radical optionally substituted by alkyl or aralkyl or secondary or tertiary amino groups; with exclusion of compounds of the oxalanilide type and compounds having 2,2,6,6 tetramethylpiperidinyl groups from the amino-functional compounds that act as aging stabilizers.

9. The composition as claimed in claim 2, wherein the at least one amino-functional compound that acts as aging stabilizer is selected from the group of the following compounds: 2,2,4-trimethyl-1,2-dihydroquinoline (TMQ), N,N′-bis-(1,4-dimethylpentyl)-p-phenylenediamine, N-isopropyl-N′-phenyl-p-phenylenediamine, N-(1,3-dimethylbutyl)-N′-phenyl-p-phenylenediamine, N-phenyl-1-naphthylamine, N-phenyl-1-naphthylamine, bis(4-octylphenyl)amine (also octylated diphenylamine) and styrenized diphenylamine.

10. The composition as claimed in claim 2, wherein a total amount of amino-functional compounds that act as aging stabilizers which is present in the composition is 0.01% to 2% by weight based on the total weight of the composition.

11. A method of curing a composition as claimed in claim 2, wherein the composition is contacted with water.

12. A cured composition obtainable as claimed in claim 11.

13. A method for coating, adhering or sealing comprising providing the composition as claimed in claim 2.

14. The method as claimed in claim 13 comprising coating, adhering, or sealing in at least one of: the construction sector as a facade sealant, as an anticorrosive coating as a pipeline coating or as an industrial coating; the automotive sector; or the solar technology or electronics sector.

15. A substrate provided with a composition as claimed in claim 2.
